(19) United States
(12) Patent Application Publication
(10) Pub. No.: US 2006/0114769 A1
(43) Pub. Date: Jun. 1, 2006

(54) Lens holding system, optical pick-up device, and recording/reproducing device

(75) Inventors: Tomio Mashiyama, Higashihiroshima-shi (JP); Masahiro Nakamura, Higashihiroshima-shi (JP); Toshiharu Inui, Yamatokoriyama-shi (JP); Shinichi Tomoyama, Yamatokoriyama-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/270,402

(22) Filed: Nov. 8, 2005

(30) Foreign Application Priority Data
Nov. 30, 2004 (JP) JP2004-347612

(51) Int. Cl. G11B 7/00

(52) U.S. Cl. 369/44.14; 369/44.15

(57) ABSTRACT

In a lens holding system of the present invention, at least two lens protection sections protruding from a surface of a lens holding section are provided, which surface faces the optical recording medium, the lens protection sections sandwiching an objective lens therebetween. A distance between each of the lens protection sections and the optical recording medium is smaller than a distance between the objective lens and the optical recording medium. Accordingly, according to the structure mentioned above, because each of plural lens protection sections is independently provided, spaces between (i) adjacent lens protection sections and (ii) each of the lens protection sections and the lens holding section are easily formed. This makes it possible to easily perform attachment/detachment of the objective lens to/from the lens holding section. Further, a region for releasing heat is easily formed by the space provided between adjacent lens protection sections mentioned above. Therefore, it becomes possible to prevent temperature rise, caused by generation of heat in driving sections, of the objective lens and a region surrounding the objective lens.

This Nonprovisional application claims priority under 35 U.S.C. §119(a) on Patent Application No. 347612/2004 filed in Japan on Nov. 30, 2004, the entire contents of which are hereby incorporated by reference.

### FIELD OF THE INVENTION

The present invention relates to a lens holding system for holding an objective lens provided in an optical pick up device, the optical pick up device including this lens holding system, and a recording/reproducing device.

### BACKGROUND OF THE INVENTION

Optical disks such as a CD-ROM (Compact Disk Read Only Memory), CD-R (Compact Disk Recordable), CD-RW (Compact Disk Rewritable), DVD-ROM (Digital Versatile Disk Read Only Memory), and DVD-RW (Digital Versatile Disk Rewritable) are, in general, widely used as information recording media having high capacity. In a disk drive device (which is also called a recording/reproducing device) for recording and/or reproducing information into/from these optical disks, an optical pick up for recording and/or reproducing the information by irradiating light on an optical disk is provided. An objective lens for converging the light onto the optical disk is mounted in this optical pick up. The lens holding system holds the objective lens provided in this disk drive device.

In FIG. 7, a conventional structure of a lens holding system is illustrated. As illustrated in FIG. 7, the lens holding system 100 includes an objective lens 110, a lens holder 120, a lens protector 130, a focusing coil 140, a tracking coil 150, and the like. The objective lens 110 converges, to substantial diffraction limit, a laser emitted from a main body of the optical pick up (not illustrated) including a laser emission system in order to read a signal in the optical disk. The lens holder 120 holds the objective lens 110. The lens protector 130 is attached to the lens holder 120 in order to protect the objective lens 110 and has a circular shape. The focusing coil 140 is attached to the lens holder 120 and drives the lens holder 120 in a focus direction (a direction parallel to a direction of an arrow P as illustrated in FIG. 7, a direction in which the lens is moved to focus). The tracking coil 150 is attached to the lens holder 120 and drives the lens holder 120 in a tracking direction.

Next, with reference to FIG. 8, and FIGS. 9(a) through 9(c), an operation of the lens holding system 100 is explained. FIG. 8 and FIGS. 9(a) through 9(c) are sectional views taken along X-X′ of the lens holding system 100 as illustrated in FIG. 7. The focusing coil 140 is not illustrated in these drawings. As illustrated in FIG. 8, in order to read a signal inscribed in an optical disk 300 or write a signal into the optical disk 300, a laser 115 emitted from a laser emission system, which is not illustrated, is directed to be incident on the objective lens 110 by optical parts that are not illustrated. The objective lens 110 includes two curved surfaces formed in order to converge the laser onto a signal inscription layer (or a signal write layer) 300a of the optical disk 300 to substantial diffraction limit. The circular optical disk 300 is driven so as to rotate at a predetermined rotation frequency by a rotation driving system that is not illustrated. When the optical disk 300 rotates, a surface of the optical disk 300 vibrates (swings) in a P direction due to a warp or distortion of the optical disk 300. At the same time, the optical disk 300 vibrates in a Q direction because of a discrepancy between a center of rotation in the rotation system that is not illustrated and a mechanical center of the disk.

In response to the surface vibration in the P direction, the objective lens 110 is driven to move in the same direction together integrally with the lens holder 120. By moving this objective lens 110 so as to maintain a constant distance with the signal inscription layer 300a of the optical disk 300, the signal reading is kept at an excellent quality level. The signal written is also kept at an excellent quality level.

Each of FIGS. 9(a) through 9(c) illustrates a state in which the objective lens 110 changes a position according to the surface vibration of the optical disk 300 in the P direction. FIG. 9(a) illustrates a condition in which the surface of the optical disk 300 does not vibrate at all. FIG. 9(b) illustrates a condition in which the surface of the optical disk 300 moves in a direction of a P1 arrow. FIG. 9(c) illustrates a condition in which the surface of the optical disk 300 moves in a direction of the arrow P2. As FIG. 9(b) illustrates, when the surface of the optical disk 300 moves in the direction of the arrow P1, the objective lens 110 and the lens holder 120 follow the movement and change their positions in a direction of an arrow P1′. Moreover, as illustrated in FIG. 9(c), when the surface of the optical disk 300 moves in the direction of the arrow P2, the objective lens 110 and the lens holder 120 follow the movement and change their positions in the direction of an arrow P2′.

The follow-up operation as mentioned above is carried out by establishment of a servo system made of a follow-up circuit that is not illustrated. The follow-up operation uses an accidental error signal that shows a deviation from an optimal distance between the optical disk 300 and the objective lens 110, which optimal distance keeps the signal at the excellent quality level,.

The lens holder 120 moves in the focus direction in a manner as mentioned above. However, in a driving system of the lens holder 120, disorder (called servo disorder) in the operation following the movement of the optical disk 300 occurs on rare occasions. In such occasions, the lens holder 120 is turned into a free vibration state or a forced vibration state. In this case, the objective lens 110 and the optical disk 300 may approach each other extraordinarily and eventually collide.

When the driving system of the lens holder 120 falls into such a state, concentric scratches are made on the surface 300b (Refer to FIG. 10) of the optical disk. 300, which surface faces the lens. Also, a scratch is made on the surface of the objective lens 110. In an extreme case, it becomes difficult to read/write a signal from/into the optical disk 300.

In order to solve the problem, as illustrated in FIG. 10, in the lens holding system 100, the lens protector 130, which has a circular shape, is provided on the lens holder 120 so as to prevent a collision between the objective lens 110 and the optical disk 300. A distance A′ between the lens protector 130 and the surface 300b of the optical disk 300, which surface faces the lens, is arranged to be smaller than a distance A between the objective lens 110 and the surface 300b of the optical disk 300, which surface faces the lens.

For example, Japanese Unexamined Patent Publication 222535/2002 (published on Aug. 9, 2002) discloses an optical pick up device realizing this. The optical pick up device disclosed in Japanese Unexamined Patent Publication 222535/2002 has a structure, in which a coating layer is formed on the surface of the lens protector, which surface faces the optical disk, and protrudes towards the optical disk more than the objective lens, the lens protector being formed so as to surround the objective lens.

However, when a lens protector having the circular shape and entirely surrounding all the periphery of the objective lens as mentioned above is formed so as to protrude toward the optical disk more than the objective lens, there is a problem in that it is difficult to attach or detach the objective lens. This is because the lens protector hinders the attachment or the detachment. Moreover, when the objective lens is attached to the lens holder by an adhesive material in the optical pick up device having the lens protector of the shape mentioned above, it is difficult to apply the adhesive material.

Furthermore, when the lens protector entirely surrounds the objective lens, a region from which heat is exhausted is limited. Accordingly, there arises a problem in that a temperature around the objective lens rises because of heat generated by an objective lens driving coil.

### SUMMARY OF THE INVENTION

The present invention has been attained in view of the problems mentioned above. An object of the present invention is to achieve a lens holding system, and an optical pick up device including the lens holding system, and a recording/reproducing device; the lens holding system (i) being capable of performing attachment and detachment of an objective lens easily and (ii) further being capable of preventing temperature rise, when a lens protector for preventing collision of the objective lens and the optical disk is provided.

In order to solve the problem mentioned above, a lens holding system, which is provided in a pick up device that records and/or reproduces information into/from an optical recording medium, includes: an objective lens for converging light on the optical recording medium; a lens holding section for holding the objective lens; and driving sections for moving the objective lens and the lens holding section, wherein the lens holding section includes at least two protruding lens protection sections on a surface facing the optical medium, the lens protection sections sandwiching the objective lens therebetween, and a distance between each of the lens protection sections and the optical recording medium is smaller than a distance between the objective lens and the optical recording medium.

The lens holding system of the present invention is provided in the optical pick up device for recording and/or reproducing information into/from the optical recording medium. This lens holding system includes the objective lens, the lens holding section for fixing the objective lens by holding a side surface of the objective lens, for example, and the driving section for moving the objective lens and the lens holding section in each of the tracking direction and the focus direction.

The lens holding system further includes the lens protection sections on the surface of the lens holding section, which faces the optical recording medium. The distance between each of the lens protection sections and the optical recording medium is smaller than the distance between the objective lens and the optical recording medium. Namely, the lens protection section is formed so as to be closer to the optical recording medium than the objective lens. This can prevent a collision between the optical recording medium and the objective lens by causing this lens protection section to collide with the optical recording medium first even in a case where the servo deviation occurs in the driving system of the objective lens.

The distance between the objective lens and the optical recording medium is a distance between a part at which the objective lens is closest to the optical recording medium and a surface of the optical recording medium, which faces the lens. Moreover, the distance between the lens protection section and the optical recording medium is a distance between a part at which the lens protection section is closest to the optical recording medium and the surface of the optical recording medium, which faces the lens.

In the lens holding system of the present invention, at least two lens protection sections sandwiching the objective lens therebetween are provided. Namely, according the structure mentioned above, because each of plural lens protection sections is independently provided, spaces between (i) adjacent lens protection sections and (ii) each of the lens protection sections and the lens holding section are easily formed. This makes it possible to easily perform attachment/detachment of the objective lens to/from the lens holding section. Further, a region for releasing heat is easily formed by the space provided between adjacent lens protection sections mentioned above. Therefore, it becomes possible to prevent temperature rise, caused by generation of heat in the driving section, of the objective lens and a region surrounding the objective lens.

An optical pick up device of the present invention includes any one of the lens holding systems mentioned above. According to this optical pick up device, the attachment/detachment of the objective lens can be performed easily and the temperature rise of the device can be prevented because any one of the lens holding system mentioned above is included. Moreover, according to the optical pick up device mentioned above, the errors in reading and writing and the like caused by the adherence of the scraped substance produced by the collision between the lens protection section and the optical recording medium to the objective lens can be prevented.

According to the present invention, a recording/reproducing device includes the optical pick up device and performs at least recording or reproduction of information into/from the optical recording medium. Therefore, the recording/reproducing device of the present invention can perform the attachment/detachment of the objective lens easily and prevent the temperature rise of the device because the recording/reproducing device includes the optical pick up device mentioned above. Moreover, according to the recording/reproducing device, errors in reading and writing and the like caused by the adherence of the scraped substance, produced by the collision between the lens protection section and the optical recording medium, onto the objective lens can be prevented. Accordingly, reading and/or writing of the information can be performed favorably.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a plan view of a structure of a lens holding system according to an embodiment of the present invention.

FIG. 2 is a plan view of a part of the lens holding system as illustrated in FIG. 1.

FIG. 3 is a side view of a part of the lens holding system as illustrated in FIG. 1, when the part is viewed from a side in which lens protectors are provided adjacent with respect to an objective lens in a tracking driving direction.

FIG. 4(a) is a side view illustrating a condition in which a part of the lens holding system as illustrated in FIG. 1 is positioned at an outermost periphery side of an optical disk, when the part is viewed from a side in which a lens protector is provided adjacent with respect to an objective lens in a direction of an optical disk rotation.

FIG. 4(b) is a plan view illustrating a condition in which a part of the lens holding system is positioned at the outermost periphery side of the optical disk.

FIG. 5 is a side view illustrating another example of the lens holding system of the present invention.

FIG. 6 is a plan view of yet another example of the lens holding system of the present invention.

FIG. 7 is a plan view illustrating a structure of a conventional lens holding system.

FIG. 8 is a sectional view of the conventional lens holding system as illustrated in FIG. 7.

FIGS. 9(a) through 9(c) are sectional views illustrating conditions in which the conventional lens holding system as illustrated in FIG. 8 follows movements of a surface of the optical disk and changes a position.

FIG. 10 is a side view of a part of the lens holding system as illustrated in FIG. 8.

FIG. 11 is a side view of a part of the conventional lens holding system.

### DESCRIPTION OF THE EMBODIMENTS

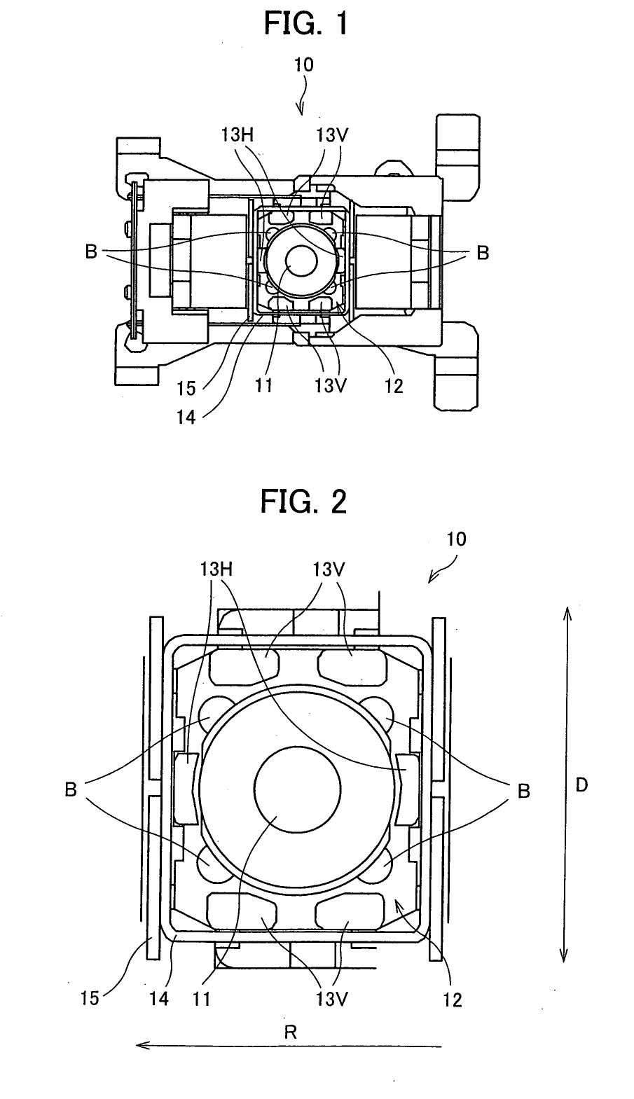

An embodiment of the present invention is explained as follows with reference to FIGS. 1 through 4(a) and 4(b). In this embodiment of the present invention, a lens holding system of an optical pick up device provided in a recording/reproducing device is given as an example for the explanation. The recording/reproducing device records and/or reproduces information by irradiating a beam of light on an optical disk which is caused to be in a rotating state.

FIG. 1 illustrates a structure of a lens holding system 10 of this embodiment. Moreover, in FIG. 2, an area around the objective lens 11 of the lens holding system 10 more greatly magnified and illustrated. As illustrated in FIG. 1, the lens holding system 10 includes the objective lens 11, a lens holder (lens holding section) 12, plural lens protectors (lens protection sections) 13V and 13H, a focusing coil (driving section) 14 and a tracking coil (driving section) 15. The objective lens 11 converges a laser emitted from a main body of an optical pick up device, including a laser emission system, to substantial diffraction limit in order to read a signal in the optical disk. The optical pick up device is not illustrated in the drawing. The lens holder 12 holds the objective lens 11. The plural lens protectors 13V and 13H are attached so as to protrude from the lens holder 12 so that the objective lens 11 is protected. The focusing coil 14 drives the lens holder 12 in a focus direction. The tracking coil 15 drives the lens holder 12 in a tracking direction.

The lens protectors 13V and 13H are arranged so that the lens protectors 13V and 13H are provided closer to a surface 300b, which faces the lens, of an optical disk 300 than the objective lens 11 in order to prevent direct contact between the objective lens 11 and the optical disk (optical recording medium) 300. To be more specific, a distance from an end section of each of the protruding lens protectors 13V and 13H to the surface 300b of the optical disk 300, which surface faces the lens, is smaller than a distance from a part, closest to the optical disk 300, of the objective lens 11 to the surface 300b of the optical disk 300, which surface faces the lens. If a servo deviation should occur in a driving system of the lens holding system 10, the optical disk 300 and either/both of the lens protectors 13H and 13V would collide first due to the structure explained above. Accordingly, the collision between the objective lens 11 and the optical disk 300 can be prevented.

In a structure in which a collision between the optical disk 300 and either/both of the lens protectors 13H and 13V is likely, it is preferable that each of the surfaces of the lens protectors 13H and 13V is formed by a material softer than a material constituting the optical disk 300. In this embodiment, a coating layer (not illustrated) is formed on each of the surfaces of the lens protectors 13H and 13V by a damping material. This can prevent formation of a scratch on the optical disk 300 even when the optical disk 300 and either/both of the lens protectors 13H and 13V collide.

As illustrated in FIG. 1 and FIG. 2, in the lens holding system 10 of this embodiment, each of four lens protectors 13V and two lens protectors 13H independently protrudes from the surface of the lens holder 12, which surface faces the optical disk. The lens protectors 13V and 13H are categorized into (i) lens protectors 13V and (ii) lens protectors 13H. The lens protectors 13V are arranged to be adjacent with respect to the objective lens 11 in a tracking driving direction (D). The lens protectors 13H are arranged to be adjacent with respect to the objective lens 11 in a rotation direction (R) of the optical disk 300. The tracking driving direction (D) crosses the rotation direction (R) of the disk at right angles.

The lens protectors 13V are arranged to be adjacent to the objective lens 11 in the tracking driving direction. A pair of two (total four) lens protectors are respectively provided on sides of the objective lens in the tracking driving direction. The lens protector 13H is arranged to be adjacent to the objective lens 11 in the rotation direction of the optical disk 300. One lens protector 13H (total two) is provided on each side of the objective lens 11 in the rotation direction.

In this way, in this embodiment, one lens protector does not surround an entire periphery of the objective lens 11. However, each of the plural lens protectors is provided independently and the plural lens protectors surround the objective lens 11. This makes it possible to provide a region for application of an adhesive material for attaching the objective lens 11 to the lens holder 12 in a space between two adjacent lens protectors. In the lens holding system 10, each adhesive material application region B is provided in a space between positions on which the lens protector 13H and the lens protector 13V are respectively formed on the surface of the lens holder 12, which surface faces the lens.

Moreover, a space is provided between individual lens protectors, and a distance between a surface 12a of the lens holder 12, which surface faces the optical disk and located in the space, and the optical disk is larger than the distance between the objective lens 11 and the optical disk. This allows the attachment of the objective lens 11 and the detachment of the objective lens 11 from the lens holder 12 to be performed easily. Furthermore, because a space is provided between the individual lens protectors as mentioned above, a space from which heat is exhausted can be provided. Accordingly, temperature rise, caused by generation of heat by the focusing coil 14 and the tracking coil 15, of the objective lens 11 and a region around the objective lens 11 can be prevented.

Two of the lens protectors 13V arranged adjacent to the objective lens 11 in the tracking driving direction (D) are provided on each side of the objective lens 11. Namely, instead of providing one lens protector, two smaller lens protectors 13V having substantially same size are provided on one side adjacent to the objective lens in the tracking driving direction (D). These two lens protectors 13V are provided in a straight line substantially parallel to the rotation direction (R) of the optical disk 300.

This forms a space between two lens protectors 13V provided on the same side with respect to the objective lens 11. This space is in a position substantially facing a center section of a diameter of the objective lens 11 in the rotation direction (R) of the optical disk 300. In this way, two smaller lens protectors 13V instead of one lens protector are provided on one side of the objective lens 11 in the tracking driving direction and includes, between the two lens protectors 13V, the space in the position substantially facing the center section of the diameter of the objective lens 11 in the rotation direction (R) of the optical disk 300. This makes it possible to reduce a distance between (i) each of the lens protectors 13V having certain width in the tracking direction and (ii) the objective lens 11. This allows the size of the lens holder 12 to be reduced in the tracking driving direction. Moreover, in the structure mentioned above, because a further space is formed around the objective lens 11, the temperature rise, caused by the generation of heat by the focusing coil 14 and the tracking coil 15, of the objective lens 11 and the region around the objective lens 11 can be prevented.

In this embodiment, although two smaller lens protectors 13V instead of one lens protector are provided on the same side with respect to the objective lens 11, the present invention is not limited to this. Only one lens protector provided on each side of the objective lens 11 in the tracking driving direction (D) is also included in the scope of the present invention. In a case where two smaller lens protectors 13V instead of one lens protector are not provided on one side in this way, by causing the one lens protector to have a shape concaved substantially at the center section of the one lens protector with respect to the rotation direction (R) of the optical disk 300, the size of the lens holder 12 can be reduced in the tracking driving direction.

As mentioned above, the coating layer made of a damping material is provided on the surfaces of the lens protectors 13V and 13H, and a collision between the objective lens 11 and the optical disk 300 is prevented by causing the lens protector 13V or 13H to collide with the optical disk 300 first.

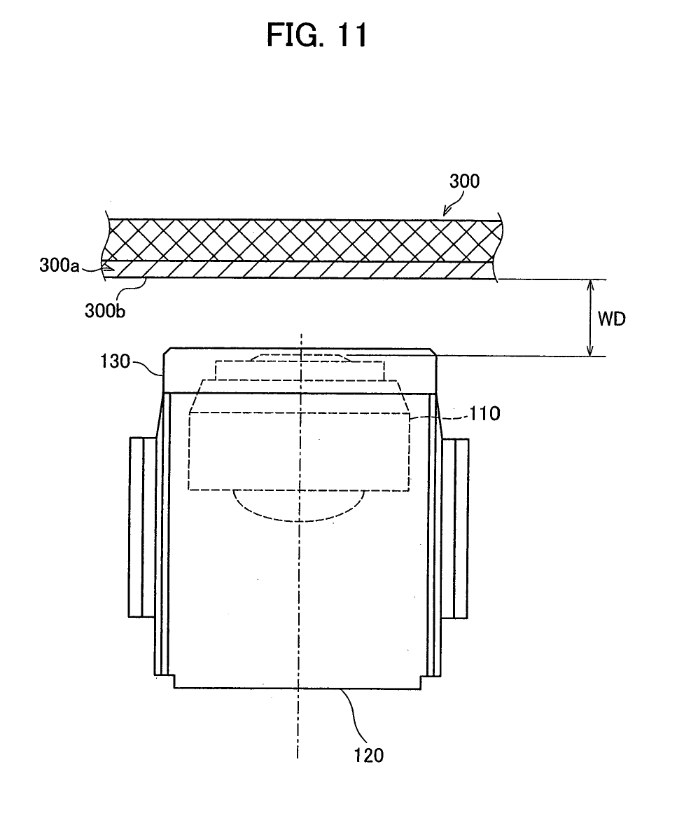

However, in the structure mentioned above, there arises a problem in that the coating layer made of a soft material is scraped due to the collision between the optical disk 300 and the lens protector 13V or 13H, and that the coating layer than adheres to the objective lens 11. Especially, when the optical disk 300 is a Blue-ray disk (BD), a WD (Working Distance) between the surface 300b of the optical disk 300, which surface faces the lens, and the objective lens 110 is as close as substantially 0.2 mm, as illustrated in FIG. 11. Because of this, the collision between the optical disk 300 and the lens protector 130 is prone to occur. Therefore, there arises a problem in that an error in reading the optical disk occurs because of a scraped substance being adhered onto the objective lens 110 at every collision.

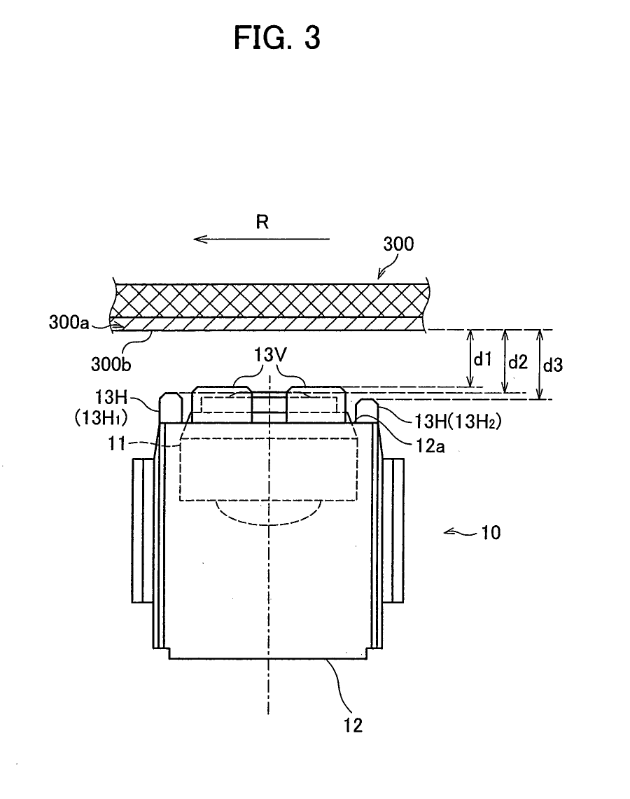

In order to solve the problem, in the lens holding system 10 of this embodiment, as illustrated in FIG. 3, the distance (d2 and d3) between (i) each of the lens protectors 13H (13H₁ and 13H₂) provided adjacent to the objective lens in the rotation direction (R) of the optical disk 300 and (ii) the surface 300b of the optical disk 300, which surface faces the lens, is arranged to be larger than a distance (d1) between (i) the lens protector 13V provided adjacent to the objective lens in the tracking driving direction (D) and (ii) the surface 300b of the optical disk 300, which surface faces the lens.

In other words, regarding a distance from the surface 12a, which faces the optical disk 300, of the lens holder 12 to a top end of each protruding section of the lens protectors (herein, this is called a height of the lens protector), the height of the lens protector 13V provided adjacent to the objective lens 11 in the tracking driving direction (D) is arranged to be the largest.

In the above structure, the lens protector 13V preferably collides first with the optical disk 13V. The substance scraped from the lens protector 13V due to the collision is not carried over to the objective lens 11 when the optical disk 300 rotates. Accordingly, the scraped substance produced by a collision between the lens protector 13V and the optical disk 300 can be prevented from being carried over to the objective lens 11 and adhered then to there, when the optical disk 300 rotates.

As mentioned above, in the lens holding system 10, the lens protector 13V provided adjacent to the objective lens in the tracking driving direction (D) mainly serves a function for preventing a collision between the objective lens 11 and the optical disk 300. Accordingly, in the present invention, the lens protector 13H arranged adjacent to the objective lens in the rotation direction of the optical disk 300 does not need to be provided necessarily.

However, when the lens holding system, which has a structure provided with only the lens protector 13V arranged to be adjacent to the objective lens 11 in the tracking driving direction, performs recording and/or reproduction at the outermost periphery section of the optical disk, there is a risk in which the objective lens 11 and the optical disk 300 collide.

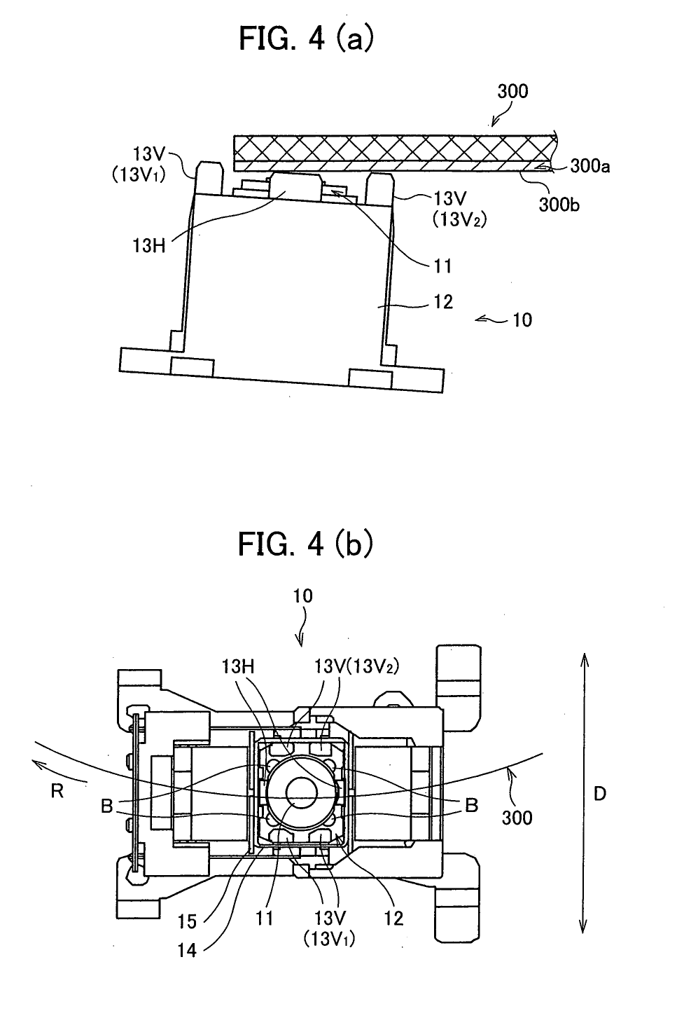

In order to solve this problem, in the lens holding system 10 of this embodiment, the lens protectors 13H are respectively provided on both adjacent sides of the objective lens 11 in the rotation direction of the optical disk 300. FIGS. 4(a) and 4(b) illustrate a state in which reproduction/recording of information from/into the signal inscription layer 300a at an outermost periphery section of the optical disk 300 is carried out.

As illustrated in FIG. 4(a), at the outermost periphery section of the optical disk 300, the lens protector 13V₁ provided on an outer side of the tracking driving direction (D) is positioned off the optical disk 300. Therefore, a collision between the objective lens 11 and the optical disk 300 cannot be prevented only by the lens protector 13V₂ provided on inner side of the tracking driving direction (D). The lens protector 13H provided adjacent to the objective lens 11 in the rotation direction (R) of the optical disk 300 collides with the optical disk 300 and prevents the collision between the objective lens 11 and the optical disk 300.

However, when, as mentioned above, the lens protector 13H provided adjacent to the objective lens 11 in the rotation direction (R) of the optical disk 300 and the optical disk 300 collides, the substance scraped from the lens protector 13H may be carried onto the objective lens 11 along with the rotation of the optical disk 300 and adhere to the objective lens 11.

In order to solve this problem, in this embodiment, the distance (d3) between the lens protector 13H₂ provided adjacent to the objective lens 11 on an upstream side in the rotation direction (R) of the optical disk 300 and the surface 300b of the optical disk 300, which surface faces the lens, is arranged to be larger than the distance (d2) between the lens protector 13H₁ provided adjacent to the objective lens 11 on a downstream side in the rotation direction (R) of the optical disk and the surface 300b of the optical disk 300, which surface faces the lens.

In other words, the height of the lens protector 13H₂ on the upstream side is lower than the height of the lens protector 13H₁ on the downstream side, the height being measured from the surface 12a of the lens holder 12, which surface faces the optical disk. The upstream side of the rotation direction (R) of the optical disk 300 is a side facing the optical disk 300 before the optical disk 300 passes over the objective lens 11. The downstream side of the rotation direction (R) of the optical disk 300 is the side facing the optical disk 300 that has passed over the objective lens 11.

In the structure mentioned above, between the lens protectors 13H₁ and 13H₂, which are respectively provided on both sides of the objective lens 11, the lens protector 13H₁ on the downstream side of the rotation direction (R) of the optical disk collides first with the optical disk 300 preferably to the lens protector 13H₂ on the upstream side. The substance scraped from the lens protector 13H₁ is carried onto the downstream side of the rotation direction along with the rotation of the optical disk 300, the substance being produced by the collision between the lens protector 13H₁ on the downstream side and the optical disk 300. Therefore, errors in reading and writing due to adherence of the scraped substance to the objective lens 11 can be presented.

Moreover, one example of the optical pick up device of the present invention is an optical pick up device including the lens holding system 10. Apart from the lens holding system 10, a remaining arrangement of a general optical pick up device in the conventional art is applicable to the arrangement of this optical pick up device. Accordingly, the explanation of the arrangement is omitted here.

Further, an example of a recording/reproducing device of the present invention is a recording/reproducing device, which includes the lens holding system 10 mentioned above and which performs recording and/or reproduction of information by irradiating a beam of light onto the optical disk which is caused to be in a rotating state. Apart from the lens holding system 10, a remaining arrangement of a general recording/reproducing device in the conventional art can be applied to the arrangement of this recording/reproducing device. Accordingly, the explanation of the arrangement is omitted here.

The present invention is not limited to the lens holding system mentioned above. Any arrangement including at least two lens protectors, which sandwiches the objective lens 11 therebetween, may be included in the present invention. However, in order to prevent the adherence of scraped material produced by the collision of the lens protector and the optical disk onto the objective lens, it is preferable that the lens protector is provided adjacent to the objective lens in the tracking driving direction.

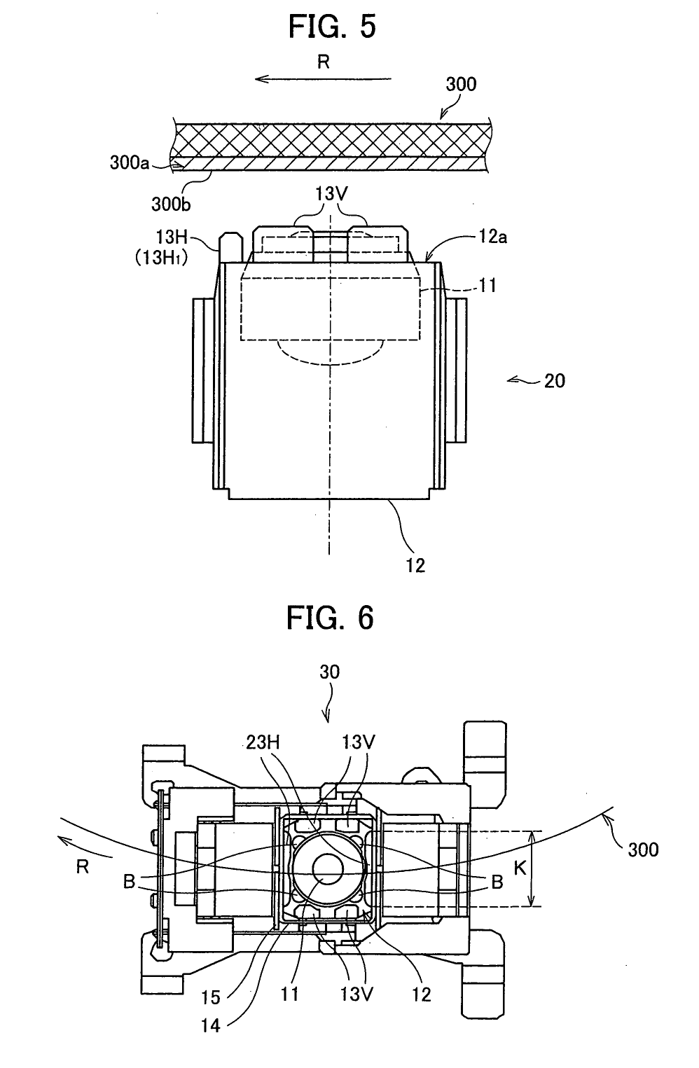

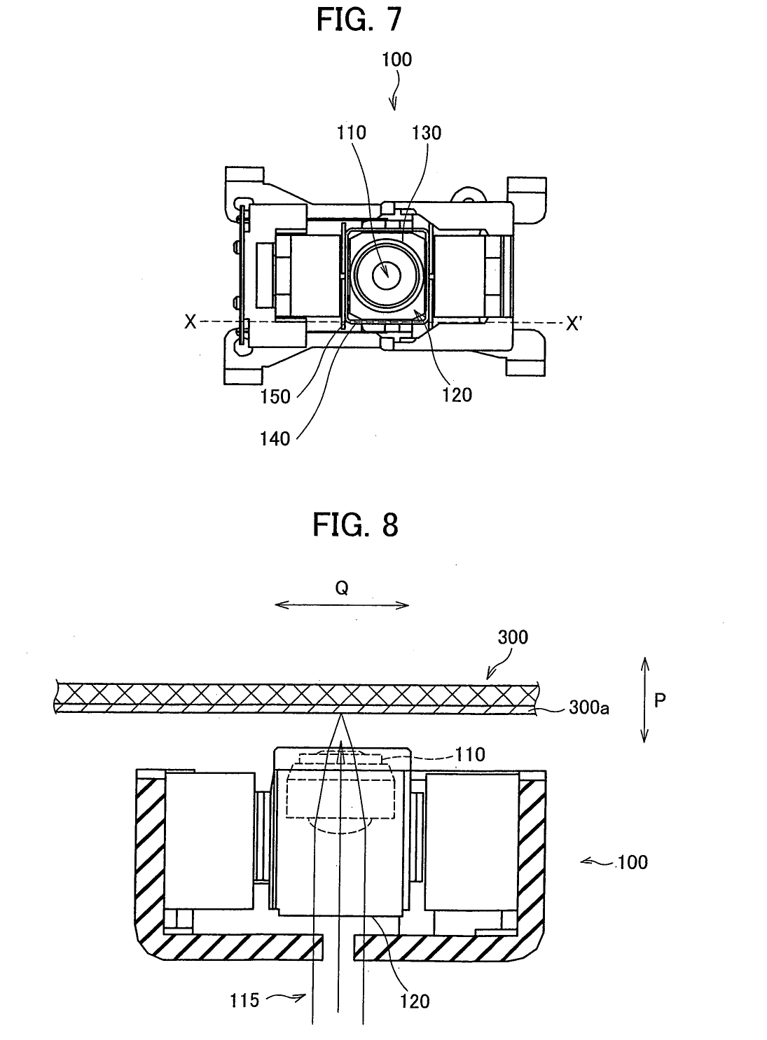

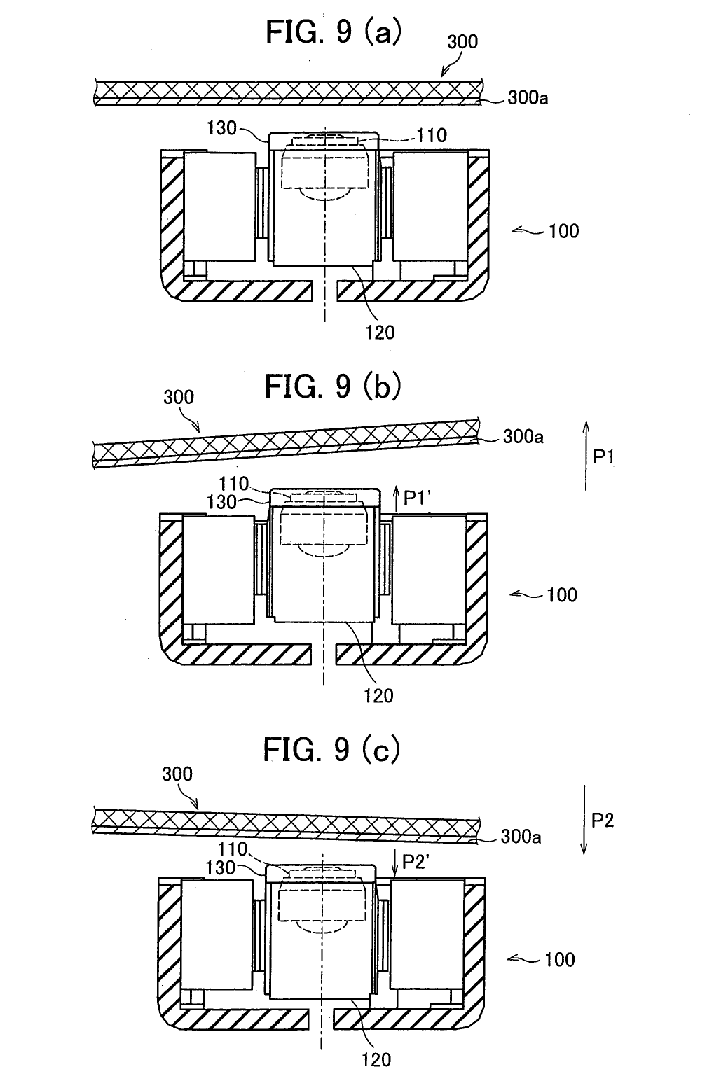

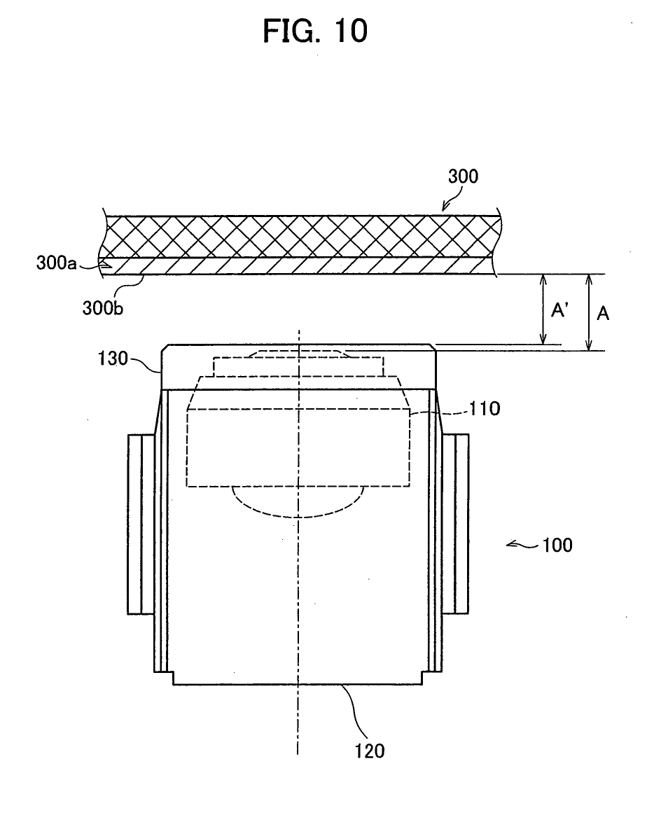

In FIG. 5, another example of the present invention is illustrated. In the lens holding system 20, only the lens protector 13H₁ adjacent to the objective lens 11 on the downstream side in the rotation direction (R) of the optical disk 300 is provided. The lens protector 13H₂ adjacent to the objective lens 11 on the upstream side in the rotation direction (R) of the optical disk 300 is not provided. In this lens holding system 20, an arrangement other than that of the lens protector 13H being provided adjacent to the objective lens 11 in the rotation direction of the optical disk 300 is same as the arrangement of the lens holding system 10 mentioned above. Therefore, in the lens holding system 20 illustrated in FIG. 5, the same part reference numbers are appended to parts having the same features as those in the lens holding system 10 illustrated in FIG. 1, and explanations thereof are omitted.

According to the arrangement mentioned above, the lens protector is not provided on the upstream side of the rotation direction (R) of the optical disk 300. Therefore, the scraped substance is not produced by a collision between the optical disk and the lens protector on the upstream side. Accordingly, the scraped substance can be prevented from being carried onto the objective lens and adhered there when the optical disk rotates.

In FIG. 6, yet another example of the present invention is illustrated. In the lens holding system 30 as illustrated in FIG. 6, the arrangement of the lens protector 23H provided adjacent to the objective lens 11 in the rotation direction (R) of the optical disk 300 is different from the arrangement of the lens protector 13H in the lens holding system 10 mentioned above. An arrangement other than this is same as the arrangement of the lens holding system 10 as illustrated in FIG. 1. The same part reference numbers are appended to parts having the same features as those in the lens holding system 10 illustrated in FIG. 1, and explanations thereof are omitted.

As illustrated in FIG. 6, width K, in the tracking driving direction (D), of the lens protector 23H is larger than an effective diameter of the objective lens 11. The effective diameter of the objective lens 11 is a value determined by (numerical aperture of the objective lens (NA))×(focal distance of the objective lens)×2.

As illustrated in FIG. 4(a), when the width, in the tracking driving direction (D), of the lens protector 13H is smaller than the effective diameter of the objective lens 11, the collision between the objective lens 11 and the optical disk 300 may not be prevented in a case where the outermost periphery section of the optical disk 300 and the lens holding system faces each other.

In order to solve this problem, the width K is arranged to be larger than the effective diameter of the objective lens 1.1 as in the lens holding system 30 illustrated in FIG. 6. This can more assuredly prevent a collision between the objective lens 11 and the optical disk 300.

As mentioned above, in order to solve the problem mentioned above, a lens holding system, which is provided in a pick up device that records and/or reproduces information into/from an optical recording medium, includes: an objective lens for converging light on the optical recording medium; a lens holding section for holding the objective lens; and driving sections for moving the objective lens and the lens holding section, wherein the lens holding section includes at least two protruding lens protection sections on a surface facing the optical medium, the lens protection sections sandwiching the objective lens therebetween, and a distance between each of the lens protection sections and the optical recording medium is smaller than a distance between the objective lens and the optical recording medium.

The lens holding system of the present invention is provided in the optical pick up device for recording and/or reproducing information into/from the optical recording medium. This lens holding system includes the objective lens, the lens holding section for fixing the objective lens by holding a side surface of the objective lens, for example, and the driving section for moving the objective lens and the lens holding section in each of the tracking direction and the focus direction.

The lens holding system further includes the lens protection sections on the surface of the lens holding section, which faces the optical recording medium. The distance between each of the lens protection sections and the optical recording medium is smaller than the distance between the objective lens and the optical recording medium. Namely, the lens protection section is formed so as to be closer to the optical recording medium than the objective lens. This can prevent a collision between the optical recording medium and the objective lens by causing this lens protection section to collide with the optical recording medium first even in a case where the servo deviation occurs in the driving system of the objective lens.

The distance between the objective lens and the optical recording medium is a distance between a part at which the objective lens is closest to the optical recording medium and a surface of the optical recording medium, which faces the lens. Moreover, the distance between the lens protection section and the optical recording medium is a distance between a part at which the lens protection section is closest to the optical recording medium and the surface of the optical recording medium, which faces the lens.

In the lens holding system of the present invention, at least two lens protection sections sandwiching the objective lens therebetween are provided. Namely, according the structure mentioned above, because each of plural lens protection sections is independently provided, spaces between (i) adjacent lens protection sections and (ii) each of the lens protection sections and the lens holding section are easily formed. This makes it possible to easily perform attachment/detachment of the objective lens to/from the lens holding section. Further, a region for releasing heat is easily formed by the space provided between adjacent lens protection sections mentioned above. Therefore, it becomes possible to prevent temperature rise, caused by generation of heat in the driving section, of the objective lens and a region surrounding the objective lens.

In addition to the arrangement mentioned above, it is preferable that, in the lens holding system, the lens protection sections are arranged adjacent with respect to the objective lens at least in a tracking driving direction of the objective lens.

Even if the lens protection section arranged adjacent to the objective lens in the tracking driving direction and the optical recording medium collide, it is rare that the substance scraped from the lens protection section by the collision carries over to the objective lens along with the rotation of the optical recording medium. Therefore, according to the arrangement mentioned above, it is possible to prevent the adherence of the scraped substances to the objective lens, the scraped substances being produced by the collision between the lens protection section and the optical recording medium.

Moreover, as mentioned above, providing the lens protection section adjacent to the objective lens at least in the tracking driving direction of the objective lens is effective. However, when the objective lens faces the outermost periphery section of the optical recording medium, a collision between the objective lens and the optical recording medium may not be prevented only by the lens protection section adjacent to the objective lens in the tracking driving direction. Therefore, it is preferable that at least one lens protection section is provided in the position adjacent to the objective lens in the rotation direction of the optical recording medium.

Thus, it is preferable that the lens holding system further includes: at least one lens protection section provided at a position adjacent to the objective lens in a rotation direction of the optical recording medium, wherein a distance between the lens protection section arranged adjacent to the objective lens in the rotation direction of the optical recording medium and the optical recording medium is larger than the distance between the lens protection section arranged adjacent to the objective lens in the tracking driving direction and the optical recording medium.

According to the arrangement mentioned above, a collision between the objective lens and the optical recording medium can be prevented even when the objective lens faces the outermost periphery section of the optical recording medium.

Moreover, according to the arrangement mentioned above, when the objective lens faces the outermost periphery section of the optical recording medium, the lens protection section, which is provided adjacent to the objective lens in the tracking driving direction, closer than the objective lens to the optical recording medium preferably collides first with the optical recording medium. The scraped substance produced by this collision is unlikely to be carried over to the objective lens along with the rotation of the optical recording medium. Therefore, the scraped substance produced by the collision between the lens protection section and the objective lens can be prevented from being carried over onto the objective lens and adhered there by the arrangement mentioned above when the optical recording medium rotates.

It is preferable that, in the lens holding system of the present invention, at least two of the lens protection sections are arranged adjacent to the objective lens in the rotation direction of the optical recording medium, the lens protection sections sandwiching the objective lens therebetween; and a distance between the lens protection section arranged adjacent to the objective lens on an upstream side in the rotation direction of the optical recording medium and the optical recording medium is larger than a distance between the lens protection section arranged adjacent to the objective lens on a downstream side in the rotation direction of the optical recording medium and the optical recording medium.

According to the arrangement mentioned above, out of the lens protection sections respectively provided on both sides of the objective lens, the lens protection section provided on the downstream side in the rotation direction of the optical device preferably collides with the optical recording medium first, rather than the lens protection section provided on the upstream side. Thus, the scraped substance produced by the collision between the lens protection section provided on the downstream side and the optical recording medium further carries onto the downstream side of the rotation direction along with the rotation of the optical recording medium. Thus, errors in reading and writing and the like caused by adherence of scraped substances to the objective lens can be prevented.

Here, the lens protection section arranged adjacent to the objective lens on the upstream side in the rotation direction is the lens protection section provided on the side facing the optical recording medium before the optical recording medium passes over the objective lens. The lens protection section arranged adjacent to the objective lens on the downstream side is the lens protection section provided on the side facing the optical recording medium after the optical recording medium has passed over the objective lens.

In addition to the arrangement mentioned above, it is preferable that, in the lens holding system of the present invention, the lens protection section arranged adjacent to the objective lens in the rotation direction of the optical recording medium is provided only on a downstream side in the rotation direction of the optical recording medium.

According to the arrangement mentioned above, because the lens protection section is not provided on the upstream side in the rotation direction of the optical recording medium, the scraped substance produced by a collision between the optical recording medium and the lens protection section on the upstream side is not produced. Therefore, it is possible to prevent the carrying of such scraped substances onto the objective lens to be adhered to the objective lens along with the optical recording medium.

It is preferable that, in the lens holding system of the present invention, a width, in the tracking driving direction, of the lens protection section arranged adjacent to the objective lens in the rotation direction of the optical recording medium is larger than an effective diameter of the objective lens.

By having the width of the lens protection section in the tracking driving direction larger than the effective diameter of the objective lens as mentioned above, the effect of protecting the objective lens is enhanced. Accordingly, a collision between the objective lens and the optical recording medium can be more assuredly prevented.

Here, the effective diameter of the objective lens is a value determined by (numerical aperture of the objective lens (NA))×(focal distance of the objective lens)×2.

It is preferable that in, the lens holding system of the present invention, at least two of the lens protection sections arranged adjacent to the objective lens in the tracking driving direction of the objective lens are provided on each side of the objective lens, and are provided in a straight line substantially parallel to the rotation direction of the optical recording medium.

According to the arrangement mentioned above, a space is formed in the position substantially facing the center section of the diameter of the objective lens in the rotation direction of the optical recording medium by dividing the lens protection section into two. By forming such a space, a lens protection section with an arbitrary width in the tracking driving direction and the objective lens can be provided more closely. This allows the size of the lens holding section in the tracking driving direction to be reduced.

Furthermore, by providing a space between adjacent lens protectors, a region for releasing heat is produced. Accordingly, the temperature rise of the objective lens and the region surrounding the objective lens can be effectively prevented.

It is preferable that, in the lens supporting system of the present invention, the lens protection section includes a coating layer including a damping material on a surface of the lens protection section.

According to the arrangement mentioned above, the surface of the lens protection section is covered by the damping material softer than a material constituting the optical recording medium. Therefore, because the damping material is scraped in a case where the lens protection section and the optical recording medium collide, formation of a scratch on the optical recording medium can be prevented.

An optical pick up device of the present invention includes any one of the lens holding systems mentioned above. According to this optical pick up device, the attachment/detachment of the objective lens can be performed easily and the temperature rise of the device can be prevented because any one of the lens holding system mentioned above is included. Moreover, according to the optical pick up device mentioned above, the errors in reading and writing and the like caused by the adherence of the scraped substance produced by the collision between the lens protection section and the optical recording medium to the objective lens can be prevented.

According to the present invention, a recording/reproducing device includes the optical pick up device and performs at least recording or reproduction of information into/from the optical recording medium. Therefore, the recording/reproducing device of the present invention can perform the attachment/detachment of the objective lens easily and prevent the temperature rise of the device because the recording/reproducing device includes the optical pick up device mentioned above. Moreover, according to the recording/reproducing device, errors in reading and writing and the like caused by the adherence of the scraped substance, produced by the collision between the lens protection section and the optical recording medium, onto the objective lens can be prevented. Accordingly, reading and/or writing of the information can be performed favorably.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A lens holding system, which is provided in a pick up device that records and/or reproduces information into/from an optical recording medium, comprising:
an objective lens for converging light on the optical recording medium;
a lens holding section for holding the objective lens; and
driving sections for moving the objective lens and the lens holding section, wherein
the lens holding section includes at least two protruding lens protection sections on a surface facing the optical medium, the lens protection sections sandwiching the objective lens therebetween, and
a distance between each of the lens protection sections and the optical recording medium is smaller than a distance between the objective lens and the optical recording medium.

2. The lens holding system as set forth in claim 1, wherein:
the lens protection sections are arranged adjacent with respect to the objective lens at least in a tracking driving direction of the objective lens.

3. The lens holding system as set forth in claim 2, further comprising:
at least one lens protection section provided at a position adjacent to the objective lens in a rotation direction of the optical recording medium, wherein
a distance between the lens protection section arranged adjacent to the objective lens in the rotation direction of the optical recording medium and the optical recording medium is larger than the distance between the lens protection section arranged adjacent to the objective lens in the tracking driving direction and the optical recording medium.

4. The lens holding system as set forth in claim 3 wherein:
at least two of the lens protection sections are arranged adjacent to the objective lens in the rotation direction of the optical recording medium, the lens protection sections sandwiching the objective lens therebetween; and
a distance between the lens protection section arranged adjacent to the objective lens on an upstream side in the rotation direction of the optical recording medium and the optical recording medium is larger than a distance between the lens protection section arranged adjacent to the objective lens on a downstream side in the rotation direction of the optical recording medium and the optical recording medium.

5. The lens holding system as set forth in claim 3, wherein:
the lens protection section arranged adjacent to the objective lens in the rotation direction of the optical recording medium is provided only on a downstream side in the rotation direction of the optical recording medium.

6. The lens holding system as set forth in claim 3, wherein:
a width, in the tracking driving direction, of the lens protection section arranged adjacent to the objective lens in the rotation direction of the optical recording medium is larger than an effective diameter of the objective lens.

7. The lens holding system as set forth in claim 2, wherein:
at least two of the lens protection sections arranged adjacent to the objective lens in the tracking driving direction of the objective lens are provided on each side of the objective lens, and are provided in a straight line substantially parallel to the rotation direction of the optical recording medium.

8. The lens supporting system as set forth in claim 1, wherein:
the lens protection section includes a coating layer including a damping material on a surface of the lens protection section.

9. The lens holding system as set forth in claim 1, wherein:
a distance between the lens holding section and the optical recording medium is larger than a distance between the objective lens and the optical recording medium.

10. An optical pick up device comprising the lens holding system as set forth in claim 1.

11. A recording/reproducing device comprising the optical pick up device as set forth in claim 9 and performing at least recording or reproduction of information into/from the optical recording medium.
